(19) United States
(12) Patent Application Publication
(10) Pub. No.: US 2009/0184293 A1
(43) Pub. Date: Jul. 23, 2009

(54) PROCESS FOR REFORMING HYDROCARBONS

(76) Inventor: Pat A. Han, Smorum (DK)

Correspondence Address: DICKSTEIN SHAPIRO LLP, 1825 EYE STREET NW, Washington, DC, 20006-5403, US

(21) Appl. No.: 12/335,363

(22) Filed: Dec. 15, 2008

(30) Foreign Application Priority Data
Jan. 18, 2008 (DK) PA2008 00068

(51) Int. Cl. C01B 3/38

(52) U.S. Cl. 252/373; 252/376

(57) ABSTRACT

The invention relates to a process for the production of synthesis gas from a hydrocarbon feedstock, wherein the entire hydrocarbon feed is passed through a radiant furnace, heat exchanger reformer and autothermal reformer in a series arrangement, and in which effluent gas from the autothermal reformer is used as heat source for the reforming reactions occurring in the heat exchange reformer.

### FIELD OF THE INVENTION

The present invention relates to a process for production of gas rich in hydrogen, particularly synthesis gas for the production of ammonia, methanol, dimethyl ether (DME), hydrogen and hydrocarbons by Fischer-Tropsch synthesis. More particularly, the invention relates to the production of synthesis gas by means of a series arrangement of radiant furnace reforming, heat exchange reforming and autothermal reforming stages, in which the heat required for the reactions in the heat exchange reforming stage is provided by hot effluent synthesis gas from the autothermal reforming stage.

### BACKGROUND OF THE INVENTION

The use of a product stream of reformed gas as a source of heat in heat exchange reforming is known in the art. Thus, EP-A-0033128 and EP-A-0334540 deal with parallel arrangements, in which a hydrocarbon feed is introduced in parallel to a radiant furnace and heat exchange reformer. The partially reformed gas from the radiant furnace is then used as heat source for the reforming reactions in the heat exchange reformer.

Other parallel arrangements combine heat exchange reforming and autothermal reforming. EP-A-0983963, EP-A-1106570 and EP-A-0504471 deal with processes in which a hydrocarbon feed is introduced in parallel to a heat exchange reformer and autothermal reformer. The hot product synthesis gas from the autothermal reformer is used as heat exchanging medium for the reforming reactions occurring in the heat exchange reformer.

In many instances it is necessary to incorporate a steam methane reforming stage by means of a radiant furnace in the process. Thus, other processes for the production of synthesis gas combine heat exchange reforming, radiant furnace and autothermal reforming. U.S. Pat. No. 4,079,017 discloses a process in which a hydrocarbon feed is introduced in parallel to a radiant furnace and heat exchange reformer. The product streams from both reformers are combined and introduced to an autothermal reformer, and the product gas from the autothermal reformer is used as heat source in the heat exchange reformer. In EP-A-0440258 we disclose a process in which the hydrocarbon feed is first passed through a first heat exchange reformer to provide a partially reformed stream. The partially reformed stream is then introduced in parallel to a radiant furnace and second heat exchange reformer. The product streams from both reformers are combined and introduced to an autothermal reformer. The product gas from the autothermal reformer is used as heat source in the second heat exchange reformer, while the product gas from said second heat exchange reformer is used as heat source in the first heat exchange reformer.

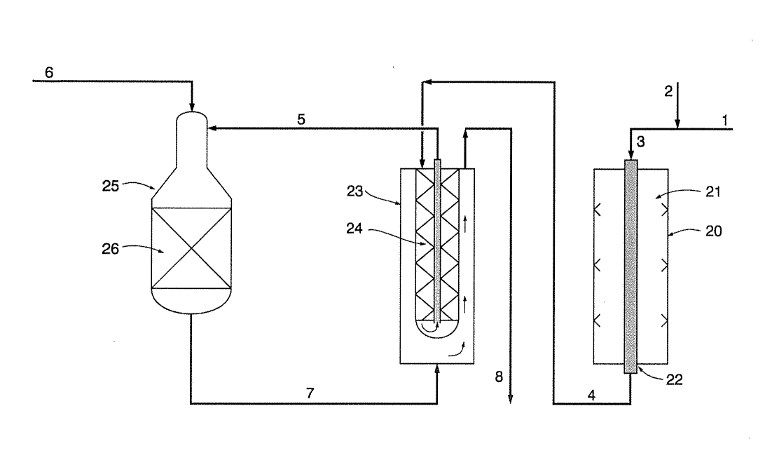

Series arrangements are also known in the art. Our patent DK 148882 discloses a process for production of synthesis gas, in which the hydrocarbon feed is passed through a heat exchange reforming and autothermal reformer, and where the product gas from the latter is used as heat source in the heat exchange reformer. U.S. Pat. No. 4,824,658 and U.S. Pat. No. 6,296,679 (FIG. 2 in both references) disclose a process in which the entire hydrocarbon feed is first introduced to a heat exchange reformer, then passed to a radiant furnace and finally to an autothermal reformer. The product gas from the autothermal reformer is used as heat source in the heat exchange reformer.

### SUMMARY OF THE INVENTION

The use of the conventional parallel and series arrangements implies several complications. Particularly, in such known arrangements with the heat exchange reformer in parallel or series with the radiant furnace and/or autothermal reformer, a portion of the heat exchange reformer will be relatively cold and therefore be subjected to metal dusting as the highly aggressive effluent gas rich in carbon monoxide from the autothermal reformer cools by its passage through the heat exchange reformer, thus resulting in metal parts falling within the prohibitive range of metal dusting temperatures.

We have now found that by providing a process in which the entire hydrocarbon feed is passed through a radiant furnace, heat exchanger reformer and autothermal reformer in a series arrangement, the risk of metal dusting is significantly reduced.

Accordingly, we provide a process for the production of synthesis gas from a hydrocarbon feedstock, comprising the steps of:

(a) reforming the hydrocarbon feedstock by adding steam to said feedstock to form a hydrocarbon-steam mixture, passing the hydrocarbon-steam mixture through a first reforming stage in a radiant furnace provided with a plurality of catalyst tubes which are heated by means of burners arranged within said radiant furnace and withdrawing a partially reformed hydrocarbon stream,

(b) passing the partially reformed stream from the radiant furnace through a second reforming stage in a heat exchange reformer provided with a plurality of catalyst tubes in heat conducting relationship with at least a portion of hot effluent of synthesis gas from step (c), and withdrawing from the heat exchange reformer a cooled effluent of synthesis gas and an effluent stream of partially reformed hydrocarbon,

(c) passing the partially reformed stream from the heat exchange reformer through an autothermal reforming stage (ATR) or partial oxidation stage (POx) provided with a fixed bed of catalyst and withdrawing a hot effluent stream of synthesis gas of which at least a portion is used as heating medium in the heat exchange reformer of step (b).

Thus, contrary to known process where the hydrocarbon feed such as natural gas is passed first to a heat exchange reforming stage prior to the radiant furnace and autothermal reformer, in the present invention the entire hydrocarbon feed is first passed through the radiant furnace, thereafter to the heat exchange reforming and finally the ATR.

By the term “catalyst tubes” is meant tubes filled with particulate catalyst thereby forming a fixed bed, or particularly for the radiant furnace tubes in which the catalyst is adhered as coating or coated in a foil adapted to the inner perimeter of the tube, or tubes in which the catalyst is coated or impregnated on structural elements such as monoliths adapted within the tubes.

The invention provides a number of advantages. When the outlet temperature from the catalyst tubes in the radiant furnace is lowered, it is possible to design the catalyst tubes with a lower design temperature and thus much cheaper than in conventional designs. By the invention, the bottom part of the reformer tubes in the radiant furnace, which is also the hottest part of the reformer and therefore design-giving, is in a way substituted by a heat exchange reformer in series with the radiant furnace, thereby enabling the design of the reformer tubes in the radiant furnace with a significantly lower design temperature. Normally in an oxygen fired autothermal reformer (secondary reformer) the inlet temperature of the gas coming directly from a radiant furnace is about 800° C. or higher in order to obtain a low methane slip. Instead of having only the radiant furnace to reach the approximately 800° C., it is now possible to reach this inlet temperature to the autothermal reformer by means of a heat exchange reformer immediately following the radiant furnace. This means that the outlet temperature from the radiant furnace becomes lower, for instance about 750° C. or lower, compared to a situation with only a radiant furnace where the outlet temperature is 800° C. or higher. The heat exchange reformer will then bring the reforming temperature up to the desired level. The required heat for reforming in the heat exchange reformer is supplied by heat exchange with the effluent process gas from the autothermal reformer, secondary reformer or partial oxidation unit (POx). By lowering the design temperature of the reformer tubes it is now also possible to design the radiant furnace to operate at much higher pressure (55-80 bar) than is normal today (25-45 bar). Higher pressures are normally necessary when increasing plant capacity although the thermodynamics of the steam reforming reaction dictate lower methane conversion. For ammonia or methanol synthesis, it can be advantageous to operate the radiant furnace at high pressure such as up to 80 bars, and consequently have the synthesis gas delivered at higher pressure to ammonia or methanol synthesis section, since less pressure boosting is required between the synthesis gas section and ammonia/methanol synthesis section.

Additionally, in contrast to conventional processes where parts of the heat exchange reformer are relatively cold and therefore prone to metal dusting due to contact with the aggressive (high CO-content) cooled effluent gas from the autothermal reforming, the present invention enables that all inlet and outlet temperatures of the radiant furnace, heat exchange reformer and autothermal reformer are above temperatures where metal dusting can take place. Since all metal parts of the heat exchange reformer and in particular the catalyst tubes are above temperatures where metal dusting can take place, the heat exchange reformer can then be made of materials that do not necessarily have to be metal dusting resistant and becomes therefore less costly.

The autothermal reforming stage may be conducted with air (21 vol % oxygen) or with enriched air, i.e. a gas containing 30-70 vol % O₂, more preferably 40-50 vol % O₂ in order to produce ammonia synthesis gas. The cooled synthesis gas leaving the heat exchange reactor may thus be subjected to carbon monoxide shift conversion for hydrogen enrichment, carbon dioxide removal and methanation in order to produce a synthesis gas having the right ratio of hydrogen and nitrogen for the subsequent ammonia synthesis.

When producing synthesis gas for e.g. hydrogen or methanol production the autothermal reforming stage may be conducted with a gas containing at least 70 vol % oxygen, preferably 100 vol % oxygen provided by dedicated air separation units.

In principle it would be desirable to avoid the use of a radiant furnace and produce the synthesis gas by the use of only the heat exchange reformer and autothermal reformer. As for instance ammonia plant capacities are on the rise with novel plants producing as much as 4000 MTPD or even more, the trend in the field has been towards avoiding the use of radiant furnaces and rather to focus only on catalytic oxygen based generation of synthesis gas, e.g. autothermal reforming (ATR) or partial oxidation (POx). Yet we find that using a radiant furnace according to the present invention is in fact advantageous as plant capacity increases. The use of a radiant furnace together with heat exchange reforming and autothermal reforming becomes particularly relevant when the autothermal reforming stage is fired with air, as it often is the case when manufacturing ammonia synthesis gas. In the absence of a radiant furnace it is necessary to fire the autothermal reformer with enriched air, as defined above, and most often with air containing 70-100% vol O₂ in order to obtain heat enough in the ATR, which is highly expensive in terms of not only operating costs, but also capital costs because of need to implement dedicated air separation units.

In the autothermal reforming stage the oxygen introduced is converted by combustion with some of the effluent gas from the heat exchange reformer. Since the combustion reaction is exothermic the temperature in the ATR is raised to about 1000-1050° C., which is also the temperature of the effluent gas leaving this reformer. By the invention the entire stream, containing hydrocarbon feed and not only a portion of it as in a conventional parallel-feed process, is also passed through the autothermal reforming stage and as a result the lowest possible methane slip is obtained as all the feed is subjected to the highest reforming temperature therein.

The molar steam-to-carbon ratio (S/C-ratio) in the hydrocarbon-steam mixture entering the radiant furnace is usually in the range 1.5-3 in order to prevent undesired methane production from the reforming steps. For the production of ammonia synthesis gas a suitable S/C-ratio is 3. Lower S/C-ratios such as 2 or 2.5 contribute to the reduction of mass flow through the process and thereby enables reduced size of equipment. However, methane slip from the ATR increases and it becomes more difficult to maintain a suitable temperature difference between the outlet temperature of the radiant furnace and the Boudouard temperature of the gas or the equilibrium temperature for CO reduction. The latter are the temperatures below which a carbon monoxide containing gas will have the potential for carbon formation following the Boudouard reaction 2CO═C+CO₂ or the CO reduction reaction CO+H₂═C+H₂O. When the partial pressure of carbon monoxide is high and the gas is in contact with a metal surface at a temperature below the Boudouard temperature or CO reduction temperature, the above reactions are catalyzed by the metal surface. If the temperature of the gas entering the heat exchange reformer is so low that the metal temperature drops below the Boudouard temperature or the CO reduction temperature, highly undesired carbon deposition on the metal surface and/or metal dusting may occur. By the invention it is now possible to lower the outlet temperature of the gas in the radiant furnace, but still the temperature is kept high enough to be outside the range of metal dusting in the heat exchange reformer. At the same time it is possible to conduct the process with an S/C-ratio as low as 2.5 or even lower with a methane slip which still is within acceptable levels, i.e. below about 0.4 dry mole% CH₄ in the effluent gas (synthesis gas) from the autothermal reforming stage for a process producing ammonia synthesis gas.

According to the invention at least a portion of the hot effluent from the autothermal reformer is used as heating medium in the heat exchange reformer. In a preferred embodiment, all the hot effluent of synthesis gas from step the autothermal reformer is used as heating medium in the heat exchange reformer.

The heat exchange reformer is preferably selected from a bayonet tube type reactor, tube and shell heat exchanger and double-tube reactor with catalyst disposed outside the double tubes and/or inside the double tubes.

In a particular embodiment of the bayonet tube type reactor, at least one reformer tube in this reformer is provided in the form of a double tube with an outer and an inner tube, the outer tube being a U-shaped tube and provided with a reforming catalyst, the inner tube being adapted to withdraw an effluent stream of partly reformed hydrocarbon from the outer tube, the outer tube being concentrically surrounded by a sleeve spaced apart the outer tube and being adapted to pass the hot effluent stream from the autothermal reformer in heat conducting relationship with reacting feedstock in the outer tube by conducting the hot effluent stream in the space between the sleeve and the outer tube.

Where the heat exchange reformer is a tube and shell heat exchanger, it is preferred that the partly reformed stream leaving the catalyst tubes in the heat exchange reformer is conducted to the autothermal reformer, while the hot effluent gas from the autothermal reformer is conducted through the shell side of the heat exchange reformer for indirect heating of reforming reactions proceeding within the catalyst tubes.

Where the heat exchange reformer is a double-tube reactor with catalyst disposed outside the double tubes and/or inside the double tubes, effluent gas from the autothermal reforming stage passes through the annular region of the double tubes, while the process gas to be further reformed is conducted through the catalyst arranged outside the double tubes and optionally also inside the double tubes. A double-tube is basically an arrangement of two substantially concentric tubes. The space in between the tubes walls defines the annular region through which a heat-exchanging medium flows, in this case effluent from the autothermal reforming stage.

After having delivered heat for the reforming reactions in the heat exchange reactor, the thus cooled synthesis gas from the autothermal reforming stage may be further processed according to its end use by converting the effluent synthesis gas into ammonia synthesis gas, methanol/DME synthesis gas, and synthesis gas for production of hydrocarbons by Fischer-Tropsch synthesis or hydrogen.

In yet another embodiment of the process, the invention further comprises passing the hydrocarbon feedstock through an adiabatic pre-reforming stage prior to conducting said first reforming stage in the radiant furnace. The provision of a pre-reforming stage in the form of adiabatic reforming by passage through a fixed bed of pre-reforming catalyst, such as a nickel based catalyst, enables removal of any traces of sulphur in the hydrocarbon feed and as a result poisoning of downstream catalyst in the radiant furnace and other downstream processes such as CO-shift conversion is eliminated. In particular we find that there is a higher propensity for the reforming catalyst in the radiant furnace to deactivate by the presence of sulphur as the outlet temperature of the reforming tubes in the radiant furnace decreases. The prereforming stage removes sulphur and delivers a gas containing only CH₄, H₂, CO, CO₂ and H₂O, which is an ideal hydrocarbon feed for the downstream reformer units. The hydrocarbon feedstock is normally mixed with process steam before entering the adiabatic pre-reforming stage, whereby particularly higher hydrocarbons such as LPG or naphtha are converted to carbon oxides and methane.

### BRIEF DESCRIPTION OF THE DRAWING

The sole FIGURE shows a flow diagram of one embodiment of the invention, in which the heat exchange reformer is a bayonet type reactor.

### DETAILED DESCRIPTION

Referring to the FIGURE, a desulfurised and preheated natural gas stream 1 is mixed with steam stream 2 to provide a hydrocarbon-steam mixture 3 with S/C-ratio of for instance 2.5. The hydrocarbon feed stream 3 is introduced to radiant furnace 20 having a number of burners 21 and catalyst filled tubes 22 arranged therein. A partially reformed hydrocarbon stream 4 having a temperature of about 750° C. is withdrawn from the radiant furnace 20 and passed to a heat exchange reformer 23 having disposed therein a number of catalyst tubes 24 of the bayonet type containing reforming catalyst. The hydrocarbon stream 4 is further converted as it passes through the catalyst filled tubes with heat provided by product gas stream 7 at about 1030° C. from autothermal reformer 25 and leaving through the inner tube as partially reformed stream 5 at about 830° C. Process gas stream 5 from the heat exchange reformer is fed to the autothermal reformer 25 having arranged therein a fixed bed of catalyst 26. In the autothermal reformer feed stream 5 is reacted with a stream 6 of oxidant such as air, oxygen enriched air or pure oxygen. A hot effluent stream 7 at about 1030° C. of synthesis gas is withdrawn. This product gas stream 7 contains hydrogen, carbon monoxide, carbon dioxide, as well as any residual methane, steam and inerts in the form of nitrogen and argon introduced with oxidant stream 6. After having delivered heat to the heat exchange reformer a cooled product gas stream 8 at about 775° C. and containing synthesis gas is withdrawn for further processing as ammonia synthesis gas, methanol/DME synthesis gas and hydrocarbon synthesis by Fischer-Tropsch or for hydrogen production.

### EXAMPLE

### Example 1

Table 1 shows the wall temperatures of a 9 m long catalyst tube of the bayonet type containing an inner tube, outer tube and sleeve as described above in a heat exchange reformer treating 209000 Nm³/h of process gas from the radiant furnace and operating at about 35 bar g for a process according to a layout as depicted in the accompanying FIGURE. The S/C-ratio in the hydrocarbon mixture-steam entering the radiant furnace is 2.5 and process air with 21 vol % oxygen is injected to the ATR. The outlet temperature of the gas from the radiant furnace is 750° C. and the temperature of the effluent gas from the ATR is 1027° C. At the bottom of the catalyst tube, the wall temperature is 949° C. and as the synthesis gas from the ATR cools on its passage through the heat exchange reformer the wall temperature of the catalyst tube decreases. At the top of the tube, where the synthesis gas leaves the heat exchange reactor, the synthesis gas temperature has decreased to 776° C., while the tube wall temperature has decreased to 765° C. Yet this wall temperature is high enough to be outside the temperature where there is risk for metal dusting (up to 750° C.). 317,000 Nm³/h of syngas leaves the ATR and thereby also the heat exchange reformer to downstream process with a methane slip of 0.27 dry mole %. Normally a methane slip of below about 0.4 dry mole % is considered to be low.

TABLE 1

| Axial distance from | Temperature of gas | Tubes wall temperature |
|---|---|---|
| inlet (%) | from ATR (° C.) | (° C.) |
| 0 (top) | 776 | 765 |
| 10 | 787 | 770 |
| 20 | 800 | 780 |
| 30 | 816 | 792 |
| 40 | 835 | 806 |
| 50 | 859 | 824 |
| 60 | 889 | 846 |
| 80 | 970 | 907 |
| 100 (bottom) | 1027 | 949 |

1. Process for the production of synthesis gas from a hydrocarbon feedstock, comprising the steps of:
(a) reforming the hydrocarbon feedstock by adding steam to said feedstock to form a hydrocarbon-steam mixture, passing the hydrocarbon-steam mixture through a first reforming stage in a radiant furnace provided with a plurality of catalyst tubes, which are heated by means of burners arranged within said radiant furnace and withdrawing a partially reformed hydrocarbon stream,
(b) passing the partially reformed stream from the radiant furnace through a second reforming stage in a heat exchange reformer provided with a plurality of catalyst tubes in heat conducting relationship with at least a portion of hot effluent of synthesis gas from step (c), and withdrawing from the heat exchange reformer a cooled effluent of synthesis gas and an effluent stream of partially reformed hydrocarbon,
(c) passing the partially reformed stream from the heat exchange reformer through an autothermal reforming stage (ATR) or partial oxidation stage (POx) provided with a fixed bed of catalyst, and withdrawing a hot effluent stream of synthesis gas of which at least a portion is used as heating medium in the heat exchange reformer of step (b).

2. Process according to claim 1, wherein all the hot effluent of synthesis gas from step (c) is used as heating medium in the heat exchange reformer of step (b).

3. Process according to claim 1, wherein the heat exchange reformer is selected from a bayonet tube type reactor, tube and shell heat exchanger, and double-tube reactor with catalyst disposed outside the double tubes and/or inside the double tubes.

4. Process according to claim 1, further comprising passing the hydrocarbon feedstock through an adiabatic pre-reforming stage prior to conducting said first reforming stage in the radiant furnace.

5. Process according to claim 1 further comprising converting the effluent of synthesis gas into ammonia synthesis gas, methanol/DME synthesis gas, synthesis gas for production of hydrocarbons by Fischer-Tropsch synthesis or hydrogen.
